(19) United States
(12) Patent Application Publication
(10) Pub. No.: US 2026/0246746 A1
(43) Pub. Date: Aug. 20, 2026

(54) Method and Device for Active Queue Management Offload

(71) Applicant: MEDIATEK INC., Hsinchu City (TW)

(72) Inventors: Sheng-Wen Hsu, Hsinchu City (TW); Ling-Yuan Chen, Hsinchu City (TW); Wei-Han Kuo, Hsinchu city (TW); Jih-Hsiang Yeh, Hsinchu City (TW)

(73) Assignee: MEDIATEK INC., Hsinchu City (TW)

(21) Appl. No.: 19/452,901

(22) Filed: Jan. 20, 2026

Related U.S. Application Data
(60) Provisional application No. 63/758,385, filed on Feb. 14, 2025.

(51) Int. Cl. H04L 47/56; H04L 43/16; H04L 47/11; H04L 47/6295; H04L 69/22

(52) U.S. Cl. CPC H04L 47/566; H04L 43/16; H04L 47/11; H04L 47/6295; H04L 69/22

(57) ABSTRACT

A method and network device for AQM offload are provided. The method includes collecting hardware resource usage data of the network device periodically and determining a congestion alarm threshold based on the collected data. A relearning timer is utilized to clean historical statistic data and adaptively adjust the congestion alarm threshold to dynamic network conditions. Incoming packets are classified into a first queue or a second queue based on an ECN field in a header of each packet. When the current hardware resource usage meets the congestion alarm threshold, the ECN field of the incoming packets is marked to notify of congestion. The method further includes scheduling transmission of the packets using an aging monitor. The packets from the first queue are transmitted prior to the packets from the second queue when a non-served time of the first queue exceeds a predetermined aging interval threshold.

### CROSS REFERENCE TO RELATED APPLICATIONS

This application claims the benefit of U.S. Provisional Application No. 63/758,385, filed on Feb. 14, 2025. The content of the application is incorporated herein by reference.

### BACKGROUND

The Low Latency, Low Loss, and Scalable Throughput (L4S) network framework has been proposed to address the increasing demand for ultra-low-latency and high-throughput communication required by real-time applications, such as virtual reality (VR), video calls, cloud gaming, and media streaming. Technical mechanisms of the L4S framework include the use of the explicit congestion notification (ECN) IPv4 packet header format for classifying L4S capability, traffic congestion detection at devices for marking ECN headers to notify next-hop devices, and a dual-queue coupled Active Queue Management (AQM) design that separates L4S traffic from legacy traffic. This design ensures that L4S traffic receives higher priority in networking devices to achieve optimal throughput.

To address this discrepancy using current methods, a network device would require the integration of high-precision time measurement hardware, such as a Precision Time Protocol (PTP) hardware module, to measure the processing time spent at the chipset. However, integrating such hardware modules significantly increases the chip cost for embedded networking devices.

Furthermore, the dual-queue coupled AQM approach introduces traffic fairness issues. Because the architecture inherently raises the priority of L4S traffic, a long-term flood of L4S traffic can cause starvation of the legacy traffic stream. This starvation leads to severe timeout issues for legacy traffic, negatively impacting the overall fairness of the network. Therefore, there is a need for a solution that provides accurate congestion detection and traffic fairness on hardware data paths without incurring high hardware costs.

### SUMMARY

An embodiment provides a method for active queue management (AQM) offload in a network device. The method includes collecting hardware resource usage data of the network device periodically and determining a congestion alarm threshold based on the collected hardware resource usage data. The method further includes classifying a plurality of incoming packets into a first queue as first packets or into a second queue as second packets based on an explicit congestion notification (ECN) field in a header of each incoming packet. When a current hardware resource usage statistic meets the congestion alarm threshold, the method involves marking the ECN field in the header of each of the plurality of incoming packets. The method further includes scheduling transmission of the first packets from the first queue and the second packets from the second queue using an aging monitor. The first packets from the first queue are transmitted prior to the second packets from the second queue when a non-served time of the first queue exceeds a predetermined aging interval threshold.

In some aspects, the hardware resource usage data comprises at least one of a buffer used rate, a buffer occupied period, a used packet ring size, a used computing rate, used power, or used DMA buffers. The method may further involve determining, by a relearning timer, an interval for cleaning historical statistic data to adaptively adjust the congestion alarm threshold, and cleaning the history statistic data partially or fully upon a timeout event of the relearning timer.

In some aspects, determining the congestion alarm threshold comprises determining a weighted moving average (WMA) of the hardware resource usage data using a current use rate of a queue and a weight of a current use rate. The method may also include storing the plurality of incoming packets in a shared memory and generating packet meta data corresponding to each packet, wherein the marking operation comprises updating the packet meta data.

An embodiment provides a network device including a memory configured to store instructions and queue data, and a traffic offload processor coupled to the memory. The traffic offload processor is configured to execute the method steps described above, including classifying packets based on ECN fields, detecting congestion via hardware usage, marking ECN headers, and scheduling transmissions using an aging monitor.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a schematic diagram illustrating a network environment in which an intelligent and cost-effective active queue management (AQM) offload method may be implemented, according to an embodiment of the present disclosure.

FIG. 2 depicts a block diagram illustrating exemplary hardware architecture of a network device configured to implement AQM offload according to an embodiment of the present disclosure.

FIG. 3 depicts an exemplary schematic diagram illustrating an operational data flow within the traffic offload processor of the network device according to an embodiment of the present disclosure.

FIG. 4 depicts a flow diagram illustrating a method for congestion detection and active queue management offload using a relearning mechanism according to an embodiment of the present disclosure.

FIG. 5 depicts a flow diagram of a method for AQM offload in the network device according to an embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. It should be noted that the present disclosure describes methods and devices operating within the Low Latency, Low Loss, and Scalable Throughput (L4S) network framework. Unless otherwise defined herein, technical terms related to network protocols—including but not limited to active queue management (AQM), explicit congestion notification (ECN), and dual-queue coupled AQM—are to be interpreted in accordance with the standards and recommendations defined by the Internet Engineering Task Force (IETF).

Specifically, the present disclosure addresses the hardware implementation challenges of the L4S architecture, which generally operates at the network layer (Layer 3) and transport layer (Layer 4). While the functional logic described herein aligns with the L4S framework to provide interoperability with standard network endpoints, the devices and methods relate to the hardware offload mechanisms that enable these standards to be met efficiently on high-speed network devices.

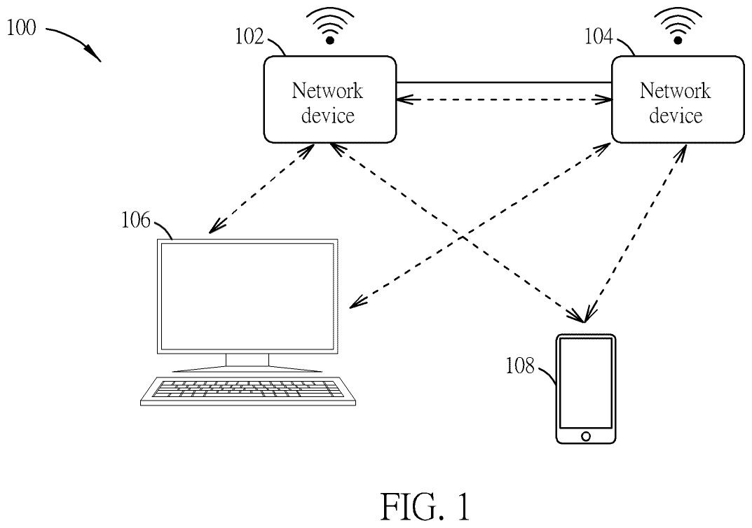

FIG. 1 depicts a schematic diagram illustrating a network environment 100 in which an active queue management (AQM) offload method may be implemented, according to an embodiment. The network environment 100 includes one or more network devices e.g., network devices 102 and 104, which communicate with one or more client devices, such as a laptop computer 106 and a mobile device 108. The network devices 102 and 104 may include any network equipment capable of routing data—such as routers, gateways, or switches—and are not limited to a specific physical medium, supporting wired, wireless, or mixed-mode traffic. The network devices 102 and 104 are configured to perform the active queue management offload method described herein, utilizing a traffic offload processor (detailed in subsequent figures) that may contain a plurality of parallel processing cores and one or more serial processing cores to handle packet processing tasks efficiently.

The client devices 106 and 108 communicate with the network devices 102 and 104 via wired, wireless, and/or wired with wireless communication links that are compatible to standard defined by IETF. In an exemplary operation, the client devices act as endpoints generating a plurality of incoming packets directed toward the network device 102. For instance, the laptop computer 106 may generate legacy traffic (e.g., file downloads), corresponding to the first packets that the network device 102 classifies into a first queue (or legacy queue). Conversely, the mobile device 108 may generate Low Latency, Low Loss, and Scalable Throughput (L4S) traffic (e.g., real-time VR or cloud gaming), corresponding to second packets that are classified into a second queue (or L4S queue).

Upon receiving these incoming packets, the network device 102 utilizes its internal hardware resources to detect congestion without relying on expensive timestamping hardware. The network device 102 checks the explicit congestion notification (ECN) field in the header of the incoming packets. If the collected hardware resource usage—such as buffer used rate or computing rate—meets a determined congestion alarm threshold, the network device 102 marks the ECN field of the packets to notify the endpoints of the congestion status.

Furthermore, the disclosed method applies to backhaul or mesh communication links existing directly between the first network device 102 and the second network device 104. If the first network device 102 experiences congestion due to high hardware resource usage, it may mark packets destined for the second network device 104 or schedule transmissions using an aging monitor. This aging monitor ensures that Legacy traffic traversing the backhaul does not suffer from starvation while the device prioritizes L4S traffic. Although FIG. 1 depicts a wireless environment, the network devices 102 and 104 may also apply the disclosed congestion detection and scheduling offload method to wired traffic interfaces (e.g., Ethernet WAN or LAN ports) without departing from the scope of the present disclosure.

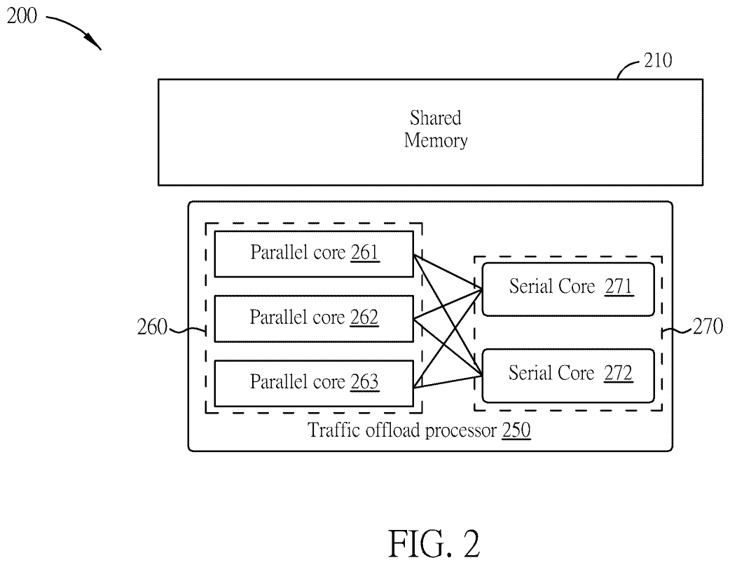

FIG. 2 depicts an exemplary hardware architecture of a network device 200 that may be configured to implement AQM offload according to an embodiment. The network device 200 may correspond to network device 102 or 104 in FIG. 1. As illustrated, the network device 200 includes a shared memory 210 and a traffic offload processor 250. The shared memory 210 may be configured to buffer a plurality of incoming packets and store associated queue data, acting as a central repository that can allow different processing units to access packet information without requiring redundant data copying. The shared memory 210 may be implemented using high-speed volatile or non-volatile memory technologies, such as static random access memory (SRAM), dynamic random access memory (DRAM), synchronous dynamic random access memory (SDRAM), magnetoresistive random access memory (MRAM), resistive random access memory (RRAM), or on-chip cache memory integrated directly within the network processor chipset.

The traffic offload processor 250 may be coupled to the shared memory 210 and can be responsible for executing the high-speed data path logic of the AQM method. The traffic offload processor 250 may be implemented as an application specific integrated circuit (ASIC), a field programmable gate array (FPGA), a system on a chip (SoC), a dedicated network processing unit (NPU), or a plurality of embedded microprocessors. To optimize processing throughput and handle the specific requirements of L4S traffic, the traffic offload processor 250 can be divided into two distinct processing groups, for example, parallel core group 260 and serial core group 270. The parallel core group 260 may include a plurality of parallel processing cores 261, 262, and 263. Similarly, the serial core group 270 may include one or more serial processing cores 271 and 272. It should be noted that the specific quantity and type of cores depicted is merely exemplary, and the present disclosure is not limited to the number of parallel or serial processing cores shown in the figure.

The plurality of parallel processing cores may be configured to handle the initial processing steps that can be executed simultaneously on multiple packets. Specifically, these parallel cores can perform the classifying of incoming packets into legacy or L4S queues based on the ECN field. Furthermore, the parallel cores may be configured to collect hardware resource usage data (e.g., buffer used rate) and perform congestion detection. If the congestion alarm threshold is met, the parallel cores may mark the ECN field in the packet header. In some embodiments, these operations can be performed by generating and updating packet metadata corresponding to the packets stored in the shared memory 210.

The one or more serial processing cores may be configured to receive the processed packet metadata from the parallel cores. These serial cores can handle the sequential processing steps, specifically the scheduling of transmission using an aging monitor. The serial cores may apply logic to determine whether to transmit packets from the first queue or the second queue, ensuring that legacy packets can be transmitted prior to L4S packets if the non-served time exceeds the predetermined aging interval threshold. This architecture can ensure that congestion detection is handled rapidly in parallel, while the final transmission order may be managed sequentially to maintain traffic fairness

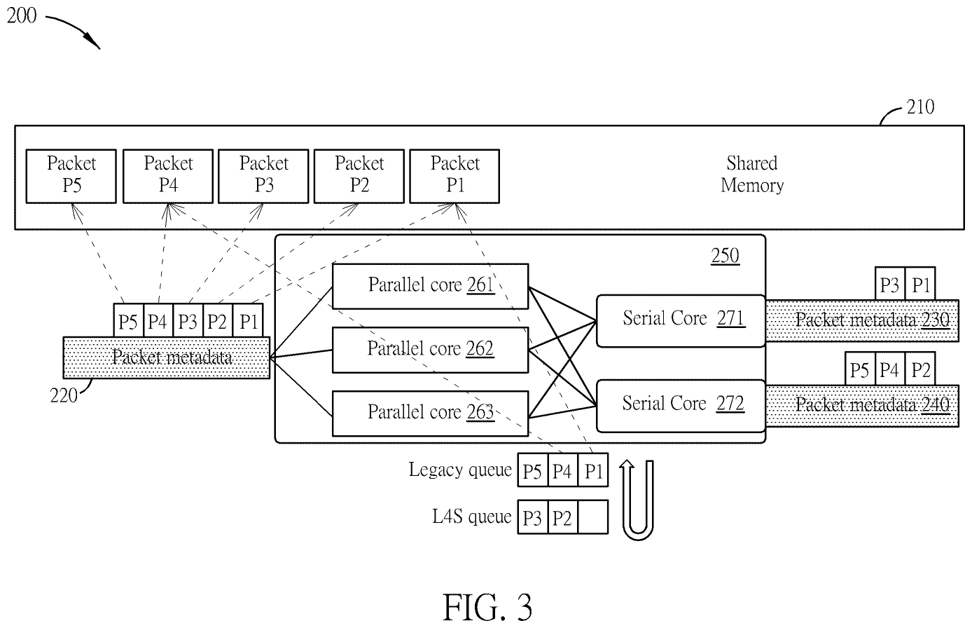

FIG. 3 depicts an exemplary operational data flow within the network device 200 according to an embodiment. The process begins with the storage of a plurality of incoming packets P1-P5, within the shared memory 210. To optimize processing efficiency and avoid the latency associated with moving large data payloads, the network device 200 generates packet metadata 220. This packet metadata 220 can serve as a lightweight descriptor for the incoming traffic, containing essential control information such as memory pointers referencing the physical location of packets P1-P5 in the shared memory 210, as well as header information (e.g., ECN fields) required for classification.

The operational flow proceeds to the parallel processing stage within the traffic offload processor 250. A parallel core group, including, for example, parallel cores 261, 262, and 263, receives the packet metadata 220 to perform the initial high-throughput tasks simultaneously. The parallel core group performs classification by analyzing the ECN field in the header of each packet. In the illustrated example, the parallel cores classify packets P1, P4, and P5 as legacy packets and packets P2 and P3 as L4S packets based on their ECN capability. Simultaneously, the parallel cores perform congestion, detection and marking by monitoring the real-time hardware resource usage of the network device 200. For instance, if the available buffer size drops below a specific threshold (e.g., ≤50%), the parallel cores detect a congestion event. In FIG. 3, this is depicted where the parallel cores update the packet metadata corresponding to packet P3 to mark the ECN field (shown as ECN (11)), thereby notifying the receiving endpoint of the congestion without interrupting the data flow.

Subsequently, the processed metadata is distributed to a serial core group, including, for example, serial cores 271 and 272, to perform scheduling. The packet metadata is partitioned for handling; for example, packet metadata 230 (representing packets P1 and P3) is routed to serial core 271, while packet metadata 240 (representing packets P2, P4, and P5) is routed to serial core 272. These serial cores manage the logical transmission queues, organizing the traffic into a legacy queue (P1, P4, P5) and an L4S queue (P2, P3).

The serial cores 271 and 272 utilize an aging monitor to determine the final transmission order. While the L4S queue is generally assigned higher priority to ensure low latency, the aging monitor prevents starvation of the legacy traffic. As indicated in the lower portion of FIG. 3, the serial cores check specific conditions, such as whether the number of legacy queued packets exceeds the number of L4S queued packets (e.g., ≥120%) or if the non-served time of the legacy queue exceeds a predetermined aging interval threshold (e.g., ≥200 ms). If these conditions are met, the serial cores can override the standard priority and schedule the transmission of the legacy packets P1, P4, and P5 prior to the L4S packets P2 and P3.

In various embodiments, the collection of hardware resource usage data is not limited to a single metric. To accurately index the congestion level without relying on expensive timestamping hardware, the network device 200 may monitor a variety of hardware states. Specifically, the collected hardware resource usage data may comprise used packet buffers, used packet ring size, used computing rate, used power, used Direct Memory Access (DMA) buffers, and a used time associated with processing each packet. By analyzing these specific hardware counters, the traffic offload processor 250 obtains a congestion index indicative of the current traffic load at the device level.

To ensure the congestion detection is stable and not triggered by transient traffic spikes, the traffic offload processor 250 may utilize a statistical approach to determine the congestion alarm threshold. In one specific embodiment, the processor calculates a Weighted Moving Average (WMA) of the hardware resource usage (e.g., the L4S packet buffer used rate). The WMA is derived according to the following formula:

$$\overline{{U}_{t}} = ( 1 - α ) \overline{{U}_{t - 1}} + α {U}_{t}$$

wherein:
U̅ₜ̅ represents the Weighted Moving Average at the current timeframe t;
α represents the weight of the current use rate (a configuration parameter);
U̅ₜ̅₋̅₁̅ represents the WMA derived at the previous timeframe; and
Uₜ represents the current use rate of the queue or hardware resource.

If the calculated average U̅ₜ̅ exceeds a defined minimum buffer size (e.g., 50% of the maximum buffer size), the congestion alarm is set.

The network device 200 further implements a relearning mechanism to adapt to dynamic network conditions and different L4S sender/receiver algorithms. A relearning timer is configured with a specific interval (e.g., every 10 ns or 300 ms) to trigger the cleaning of history statistic data. This prevents legacy data from misleading the accuracy of the congestion alarm threshold decisions. Importantly, the marking behavior includes a “latching” characteristic: once the congestion alarm is set (indicating the device has entered a congestion stage), the traffic offload processor 250 is configured to mark the ECN tag continuously on incoming packets until the congestion alarm is explicitly cleaned by updated hardware resource usage statistics or until the relearning timer experiences a timeout event.

Regarding the packet scheduler and aging monitor logic, specific thresholds may be defined to ensure traffic fairness between the legacy queue and the L4S queue. In one embodiment, the packet scheduler prioritizes the legacy queue over the L4S queue when both of the following conditions are met: (1) the number of queued packets in the legacy queue exceeds the number of queued packets in the L4S queue by a predetermined ratio (e.g., Legacy Queued Packets≥LAS Queued Packets×120%); and (2) the non-served time of the legacy queue exceeds the predetermined aging interval threshold (e.g., non-served Time ≥200 ms).

This specific logic ensures that the aging monitor does not significantly degrade the performance of the L4S traffic while preventing severe timeout issues for the legacy traffic.

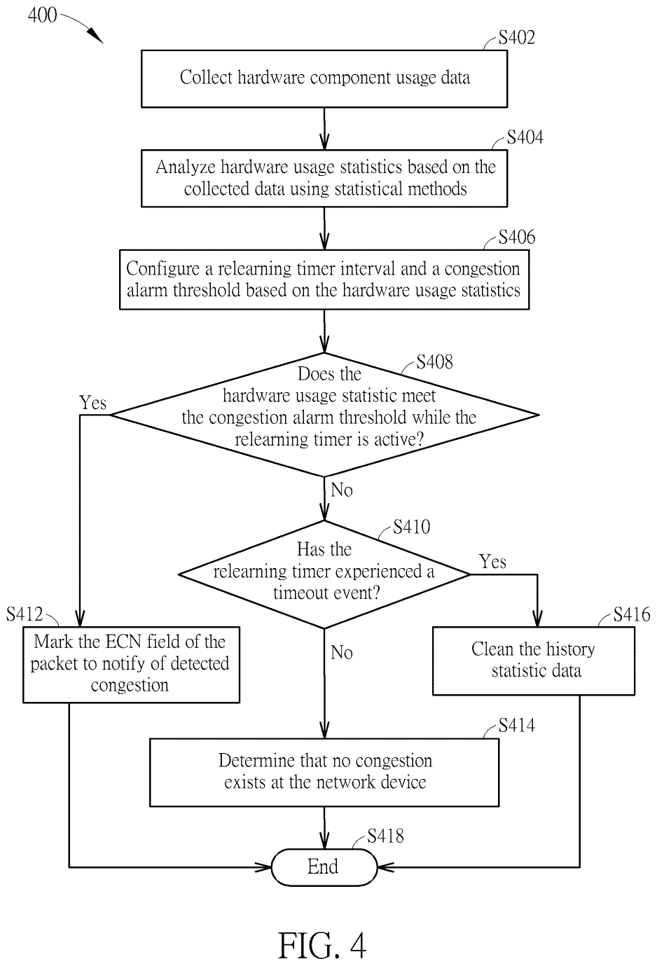

FIG. 4 depicts a flow diagram illustrating a method 400 for congestion detection and AQM offload utilizing a relearning mechanism according to an embodiment. The method 400 may be performed by the traffic offload processor of the network device described in previous embodiments. The process initiates at step S402, where the network device periodically collects hardware components' usage data to determine the current load status. This data collection may include acquiring metrics such as used packet buffers, used packet ring size, used computing rate, used power, used DMA buffers, and the time utilized for processing each packet. Subsequently, at step S404, the network device calculates and analyzes this collected data using statistical theories and pre-calibrated parameters. For instance, the processor may calculate a weighted moving average (e.g., EWMA) or perform a normal distribution analysis to smooth out transient spikes in the hardware resource usage.

At step S406, the network device evaluates the status of a relearning timer. If the relearning timer is not currently set, the method utilizes the statistical results to configure the necessary parameters. This includes setting a relearning timer interval (e.g., every 10 ns) to determine the frequency for cleaning history data, and establishing a congestion alarm threshold value (e.g., a maximum used computing power or buffer size). Ideally, both the timer interval and the threshold value are adjusted dynamically based on the statistical results to accommodate different types of L4S sender/receiver algorithms.

The method then proceeds to determining the appropriate congestion response based on the timer status and the calculated usage statistics. At step S408, the device checks if the relearning timer has not timed out and if the hardware usage statistic result concurrently meets the established threshold value. If both conditions are satisfied (indicating a valid congestion event), the method proceeds to step S412, where the network device marks the packet with an ECN tag to notify network endpoints of the detected congestion, after which the process terminates at step S418.

However, if the conditions at step S408 are not met, the method proceeds to step S410 to check if the relearning timer has experienced a timeout event. If the timer has timed out, the method moves to step S416, where the network device cleans partial or full history statistic data to ensure that outdated traffic patterns do not bias future detection. Conversely, if the timer has not timed out but the threshold was not met (at step S408), the method proceeds to step S414, determining that there is currently no congestion at the device. In this scenario, the packet is processed without ECN marking. The method concludes at step S418.

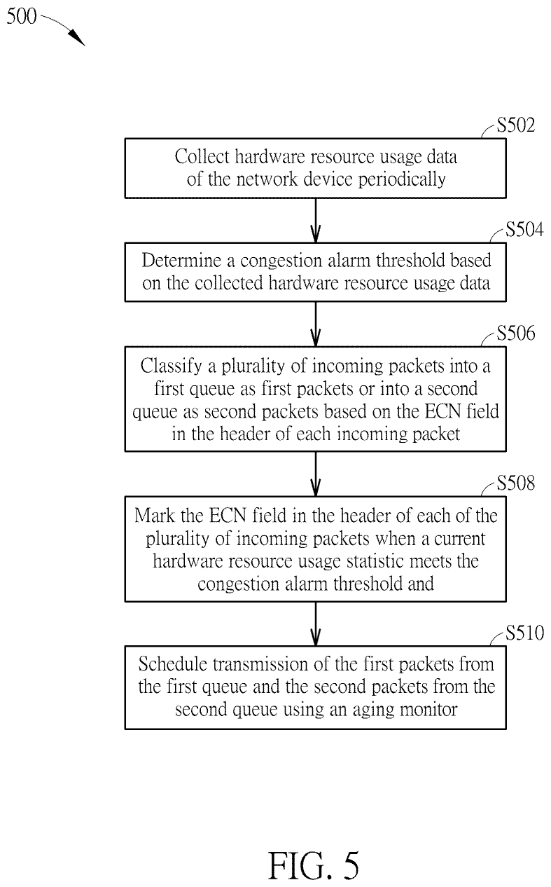

FIG. 5 depicts a flow diagram of a method 500 for AQM offload in the network device 200. The method 500 provides an intelligent and cost-effective approach to congestion detection and traffic scheduling in Low Latency, Low Loss, Scalable Throughput (L4S) network devices without requiring expensive hardware timestamp monitoring modules. The method 500 includes:
S502: Collect hardware resource usage data of the network device periodically;
S504: Determine a congestion alarm threshold based on the collected hardware resource usage data;
S506: Classify a plurality of incoming packets into a first queue as first packets or into a second queue as second packets based on the ECN field in the header of each incoming packet;
S508: Mark the ECN field in the header of each of the plurality of incoming packets when a current hardware resource usage statistic meets the congestion alarm threshold; and
S510: Schedule transmission of the first packets from the first queue and the second packets from the second queue using an aging monitor.

At step S502, the network device 200 periodically collects hardware resource usage data. In one embodiment, the hardware resource usage data comprises a plurality of metrics including, but not limited to, used packet buffer size, available buffer capacity, buffer occupancy duration, packet ring size utilization, microprocessor computing usage, processing time per packet in aggregate, direct memory access (DMA) buffer utilization, and power consumption levels. The collection of hardware resource usage data is performed at configurable periodic intervals, such as every processing cycle or at fixed time intervals, to establish a continuous monitoring of the device's operational state.

In certain embodiments employing a parallel core architecture as shown in FIGS. 2 and 3, each of a plurality of parallel processing cores 261, 262, 263 (collectively designated as parallel core group 260) independently monitors and reports hardware resource usage data during packet processing operations. The hardware resource usage data from the plurality of parallel cores 260 is aggregated and stored in a shared memory 210 accessible to all processing cores within the network device 200. This aggregation provides a comprehensive view of the device's overall resource utilization without requiring per-packet timestamp measurements, thereby avoiding the integration of costly Precision Time Protocol (PTP) hardware or similar high-precision timing modules that would otherwise be necessary to measure individual packet processing delays in the nanosecond range typical of hardware data paths.

The periodic collection of hardware resource usage data enables the network device 200 to establish congestion indicators based on actual hardware utilization rather than relying solely on packet delay measurements. By monitoring hardware resource usage, the present invention adapts congestion detection to the operational characteristics of hardware-accelerated packet processing without the computational overhead and cost burden of per-packet timestamp tracking.

At step S504, a congestion alarm threshold is determined based on the collected hardware resource usage data. The determination of the congestion alarm threshold involves statistical analysis of the hardware resource usage data to establish dynamic threshold values that adapt to current network traffic conditions. The relearning mechanism employed at this step operates as shown in greater detail in FIG. 4, which depicts a method 400 for configuring and dynamically adjusting the congestion alarm threshold through periodic relearning cycles. As illustrated in FIG. 4, the method includes collecting hardware component usage data at step S402, analyzing hardware usage statistics using statistical methods at step S404, and configuring both a relearning timer interval and the congestion alarm threshold at step S406 based on the analyzed statistics.

The congestion alarm threshold comprises one or more threshold values corresponding to various hardware resources. In one embodiment, a minimum L4S packet buffer size threshold is established, for example at 50% of maximum buffer capacity of the shared memory 210, such that when the weighted moving average of L4S packet buffer utilization exceeds this threshold, a congestion condition is detected. Additional threshold values may include maximum processing time thresholds, maximum buffer occupancy period thresholds, and maximum computing power utilization thresholds for the parallel cores 261, 262, 263, each derived from the statistical analysis of the collected hardware resource usage data.

In some embodiments, the determination of the congestion alarm threshold incorporates a relearning mechanism to prevent stale historical data from compromising the accuracy of congestion detection. As shown in FIG. 4 at decision step S408, the method evaluates whether the hardware usage statistic meets the congestion alarm threshold while the relearning timer is active. When a relearning timer is not currently set, the method establishes a relearning timer interval at step S406, for example 300 milliseconds, which defines the frequency at which historical hardware resource usage data is refreshed or reset. The relearning timer interval is configured to accommodate different L4S sender and receiver algorithm implementations and to ensure that the congestion alarm threshold remains responsive to dynamic changes in network traffic patterns.

The method can operate in three distinct states based on the relearning timer and threshold comparison, as illustrated in the decision flow of FIG. 4. In a first state, when the relearning timer has not expired and the current hardware resource usage statistic meets or exceeds the congestion alarm threshold (step S408 evaluating to “Yes”), the network device 200 enters a congestion detection state and proceeds to mark packets with explicit congestion notification indicators at step S412. In a second state, when the relearning timer has not expired and the current hardware resource usage statistic does not meet the congestion alarm threshold (step S408 evaluating to “No”), the method proceeds to decision step S410 to evaluate whether the relearning timer has experienced a timeout event. If the timer has not timed out (step S410 evaluating to “No”), the method determines at step S414 that no congestion exists at the network device 200, and normal packet processing continues without congestion marking. In a third state, when the relearning timer expires (step S410 evaluating to “Yes”), the method clears partial or full history statistic data at step S416 and recalculates the congestion alarm threshold based on fresh hardware resource usage data, thereby adapting to changed network conditions and preventing legacy data from causing inaccurate congestion assessments. After cleaning the history statistic data, the method proceeds to step S418 and ends the current relearning cycle, after which the process returns to step S402 to begin a new monitoring and analysis cycle.

The adaptive adjustment of the congestion alarm threshold through periodic relearning provides significant advantages over static threshold configurations. By continuously updating threshold values based on recent traffic patterns and hardware utilization within the shared memory 210 and across the parallel cores 260, the accurate congestion detection can be maintained across varying network conditions, different traffic mixes, and diverse L4S implementation algorithms employed by endpoint devices. This adaptability ensures that congestion is detected early enough to enable proactive congestion control while avoiding false positive detections that would unnecessarily throttle network throughput.

At step S506, a plurality of incoming packets is classified into a first queue or a second queue based on the explicit congestion notification (ECN) field in the header of each incoming packet. As shown in FIG. 3, incoming packets including Packet P5, Packet P4, Packet P3, Packet P2, and Packet P1 arrive at the network device 200 and are stored in the shared memory 210. The ECN field comprises two bits in the IPv4 packet header that indicate the congestion notification capability and status of the packet. In accordance with standard ECN encoding, packets with ECN field values of binary ‘00’ indicate Non-ECN-Capable Transport and are classified as legacy traffic, while packets with ECN field values of binary ‘01’ or binary ‘10’ indicate ECN-Capable Transport and are classified as L4S-capable traffic. Packets with ECN field values of binary ‘11’ indicate that congestion has been experienced during transit.

In one embodiment, incoming packets identified as L4S-capable based on ECN field values of ‘01’ or ‘10’ are classified as first packets and enqueued into a first queue designated for L4S traffic, shown in FIG. 3 as the L4S queue containing Packets P3 and P2. Incoming packets identified as legacy traffic based on an ECN field value of ‘00’ are classified as second packets and enqueued into a second queue designated for legacy traffic, shown in FIG. 3 as the Legacy queue containing Packets P5, P4, and P1. This dual-queue architecture enables differentiated handling of L4S and legacy traffic, with the first queue (L4S queue) receiving higher transmission priority to support the ultra-low latency requirements of L4S applications while the second queue (Legacy queue) maintains service for traditional best-effort traffic.

In embodiments employing a parallel core architecture as depicted in FIGS. 2 and 3, the classification of incoming packets is performed by the plurality of parallel processing cores 261, 262, 263 operating concurrently within the traffic offload processor 250. Each parallel processing core independently examines the ECN field of incoming packets assigned to that core and classifies the packets into the appropriate queue. Packet metadata 220, including the original ECN field value, queue assignment, arrival timestamp for aging calculations, and processing status, is stored in the shared memory 210 accessible to both the parallel processing cores 260 performing classification and serial processing cores 271, 272 (collectively designated as serial core group 270) responsible for subsequent packet scheduling operations. As shown in FIG. 3, the packet metadata 220 is associated with the incoming packets P5, P4, P3, P2, P1 at the input stage, and packet metadata 230 and packet metadata 240 are maintained by the serial cores 271 and 272 respectively for packets being processed for transmission.

At step S508, the ECN field in the header of each of the plurality of incoming packets is marked when a current hardware resource usage statistic meets the congestion alarm threshold. The marking of the ECN field serves as an explicit congestion notification to downstream network devices and endpoint receivers, enabling adaptive congestion control without requiring packet drops. In one embodiment, when the weighted moving average of L4S packet buffer utilization in the shared memory 210 meets or exceeds the minimum L4S packet buffer size threshold established at step S504, the network device 200 enters a congestion state and begins marking the ECN field of L4S-capable packets. This congestion marking operation corresponds to step S412 in the detailed relearning mechanism flow depicted in FIG. 4, where the ECN field of packets is marked to notify of detected congestion.

For packets in the first queue (L4S queue shown in FIG. 3) having ECN field values of binary ‘01’ or ‘10’ indicating ECN-Capable Transport, the ECN field is modified to binary ‘11’ to indicate Congestion Experienced. This modification notifies the receiving endpoint that congestion has been detected at the network device 200, prompting the endpoint to reduce its transmission rate in accordance with L4S congestion control algorithms. By marking the ECN field rather than dropping packets, the method maintains packet delivery while signaling congestion, thereby reducing latency, avoiding retransmission overhead, and maintaining higher overall throughput compared to drop-based congestion signaling.

The marking of the ECN field continues for all subsequent L4S-capable packets while the congestion condition persists. As illustrated in the decision flow of FIG. 4, the congestion condition is considered to persist until either the current hardware resource usage statistic falls below the congestion alarm threshold (evaluated at step S408), indicating that buffer utilization in the shared memory 210 has decreased to acceptable levels, or until the relearning timer interval expires (evaluated at step S410) and the congestion alarm threshold is recalculated based on updated hardware resource usage statistics at step S416. This approach ensures consistent congestion signaling during periods of sustained high utilization while adapting to changing network conditions through the periodic relearning mechanism.

In embodiments employing a parallel core architecture as shown in FIGS. 2 and 3, each parallel processing core 261, 262, 263 within the traffic offload processor 250 independently marks the ECN field of packets during packet processing operations based on a shared congestion state maintained in the shared memory 210. When any parallel core detects that the current hardware resource usage statistic meets the congestion alarm threshold, a congestion flag is set in the shared memory 210, causing all parallel processing cores 260 to begin marking ECN fields in L4S-capable packets. This coordinated marking across multiple processing cores ensures uniform congestion signaling regardless of which core processes a particular packet. The updated ECN markings are reflected in the packet metadata 220 stored in the shared memory 210 for access by the serial cores 270 during subsequent scheduling operations.

At step S510, transmission of the first packets from the first queue and the second packets from the second queue is scheduled using an aging monitor. As depicted in FIG. 3, the aging monitor is symbolically represented by the U-shaped element positioned adjacent to the Legacy queue and L4S queue, indicating the monitoring function that prevents starvation of legacy traffic while maintaining priority for L4S traffic. The aging monitor implements a fairness mechanism that prevents starvation of legacy traffic in the second queue (Legacy queue) while maintaining high transmission priority for L4S traffic in the first queue (L4S queue). Under normal operating conditions, the packet scheduler executed by the serial cores 271, 272 transmits packets from the first queue (L4S traffic, such as Packets P3 and P2 shown in FIG. 3) with higher priority than packets from the second queue (legacy traffic, such as Packets P5, P4, and P1 shown in FIG. 3), thereby supporting the ultra-low latency requirements of L4S applications.

The aging monitor mechanism evaluates three key parameters to determine when legacy traffic should override the default L4S priority. A first parameter comprises a queue length comparison threshold that compares the number of queued packets in the second queue (Legacy queue) to the number of queued packets in the first queue (L4S queue) as shown in FIG. 3. In one embodiment, the queue length comparison threshold is set such that legacy queue depth must equal or exceed L4S queue depth multiplied by a factor, for example 120%, before aging monitor intervention is considered. For instance, referring to FIG. 3, when the Legacy queue contains three packets (P5, P4, P1) and the L4S queue contains two packets (P3, P2), the ratio of 3:2 (150%) exceeds the 120% threshold, triggering evaluation of the second parameter. A second parameter comprises a non-served time value that tracks the elapsed time since the second queue (Legacy queue) last transmitted packets. The non-served time is maintained independently for the second queue in the packet metadata 240 associated with the serial core 272, and is reset to zero milliseconds each time packets from the second queue are transmitted. A third parameter comprises a legacy aging interval threshold that defines the maximum acceptable non-served time for legacy traffic, for example 200 milliseconds or more, which is configurable based on application requirements and desired fairness characteristics.

The packet scheduler implemented by the serial cores 271, 272 applies the following decision logic to determine packet transmission order. When both the first queue (L4S queue) and second queue (Legacy queue) contain packets awaiting transmission, as shown in FIG. 3, the scheduler evaluates whether the number of packets in the second queue equals or exceeds the number of packets in the first queue multiplied by the queue length comparison factor (e.g., 120%) and whether the non-served time tracked in packet metadata 240 equals or exceeds the legacy aging interval threshold (e.g., 200 ms). If both conditions are satisfied, the scheduler overrides the default L4S priority and transmits packets from the second queue (legacy traffic) to the outgoing interface shown at the right side of FIG. 3 (where packets P5, P4, P1, P3, P2 are being output), then resets the non-served time to zero milliseconds in the packet metadata 240. If either condition is not satisfied, the scheduler transmits packets from the first queue (L4S traffic, such as P3 and P2) according to normal high-priority handling, and increments the non-served time in the packet metadata 240 to track continued delay of legacy traffic. When only the first queue contains packets, the scheduler transmits from the first queue. When only the second queue contains packets, the scheduler transmits from the second queue.

In embodiments employing a serial core architecture for packet scheduling as depicted in FIGS. 2 and 3, the serial processing cores 271, 272 within the serial core group 270 implement the aging monitor logic by accessing packet metadata 220, 230, 240 from the shared memory 210. The serial processing cores 270 retrieve queue depth information for both the first queue (L4S queue) and second queue (Legacy queue), evaluate the queue length comparison and non-served time criteria maintained in the respective packet metadata 230, 240, and select packets for transmission to the outgoing network interface according to the aging monitor decision logic. Serial core 271 manages packet metadata 230 containing packets P3 and P1 for transmission, while serial core 272 manages packet metadata 240 containing packets P5, P4, and P2 for transmission, as shown in FIG. 3. This architecture enables efficient packet scheduling while maintaining separation between the packet classification and congestion marking operations performed by parallel processing cores 260 and the scheduling operations performed by serial processing cores 270 within the traffic offload processor 250.

In a simplified embodiment, the aging monitor may be configured with a non-served time initial value of zero milliseconds, a legacy aging interval threshold of zero milliseconds, and a minimum queue length of one packet. This simplified configuration provides basic starvation prevention while reducing computational complexity, as the scheduler intervenes immediately when the queue length disparity threshold is met without requiring extended time-based monitoring. The packet metadata 230, 240 in such embodiments would maintain minimal state information focused primarily on queue depth comparisons rather than temporal tracking.

The aging monitor mechanism provides critical fairness guarantees while maintaining the performance benefits of L4S priority scheduling. By allowing legacy traffic to override L4S priority when both queue depth disparity and extended non-served time conditions are met, as monitored through packet metadata 240 by serial core 272, the method prevents complete starvation of legacy flows that could otherwise occur during sustained periods of heavy L4S traffic flowing through the first queue. The configurable nature of the queue length comparison threshold and legacy aging interval threshold stored in the shared memory 210 enables network administrators to tune the balance between L4S performance and legacy fairness according to specific deployment requirements. Furthermore, the minimal impact on L4S traffic performance during normal conditions, combined with guaranteed service for legacy traffic within the aging interval during congestion, ensures that the network device 200 can support mixed traffic environments including both latency-sensitive applications (virtual reality, video calls, cloud gaming, media streaming) and traditional internet traffic without requiring separate physical infrastructure or complex traffic engineering.

The method 500 depicted in FIG. 5 provides a comprehensive solution to the challenges of implementing L4S networking in hardware-accelerated network devices. By collecting hardware resource usage data periodically rather than tracking per-packet timestamps, the method eliminates the need for costly high-precision timing hardware such as Precision Time Protocol modules, thereby reducing device cost while maintaining accurate congestion detection appropriate for hardware data paths operating at nanosecond timescales. By determining congestion alarm thresholds through statistical analysis and periodic relearning, the method adapts dynamically to changing network conditions and prevents both false positive and false negative congestion detections. By classifying packets into dual queues based on ECN capability and marking ECN fields upon congestion detection, the method enables proactive congestion control that maintains low latency and high throughput without requiring packet drops. By scheduling packet transmission using an aging monitor that balances L4S priority with legacy traffic fairness, the method prevents starvation issues while supporting the ultra-low latency requirements of modern real-time applications. The combination of these techniques results in an intelligent and cost-effective active queue management offload method suitable for deployment in access points, gateways, routers, and other network devices requiring support for mixed L4S and legacy traffic environments.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for active queue management offload in a network device, comprising:
collecting hardware resource usage data of the network device periodically;
determining a congestion alarm threshold based on the collected hardware resource usage data;
classifying a plurality of incoming packets into a first queue as first packets or into a second queue as second packets based on an explicit congestion notification (ECN) field in a header of each incoming packet;
marking the ECN field in the header of each of the plurality of incoming packets when a current hardware resource usage statistic meets the congestion alarm threshold; and
scheduling transmission of the first packets from the first queue and the second packets from the second queue using an aging monitor, wherein the first packets from the first queue are transmitted prior to the second packets from the second queue when a non-served time of the first queue exceeds a predetermined aging interval threshold.

2. The method of claim 1, wherein the hardware resource usage data comprises at least one of buffer used rate, a buffer occupied period, a used packet ring size, a used computing rate, used power, or used DMA buffers.

3. The method of claim 1, further comprising determining, by a relearning timer, an interval for cleaning historical statistic data to adaptively adjust the congestion alarm threshold.

4. The method of claim 3, further comprising cleaning the history statistic data partially or fully upon a timeout event of the relearning timer.

5. The method of claim 4, wherein the marking the ECN field continues until the congestion alarm threshold is cleared by the hardware resource usage statistic or a timeout of the relearning timer occurs.

6. The method of claim 1, wherein determining the congestion alarm threshold comprises determining a weighted moving average (WMA) of the hardware resource usage data.

7. The method of claim 6, wherein the weighted moving average is determined using a current use rate of a queue and a weight of a current use rate.

8. The method of claim 1, wherein the first packets from the first queue are transmitted prior to the second packets from the second queue when the number of first packets in the first queue is higher than the number of second packets in the second queue.

9. The method of claim 1, further comprising storing the plurality of incoming packets in a shared memory and generating packet metadata corresponding to each of the plurality of incoming packets, wherein the marking the ECN field comprises updating the packet metadata.

10. A network device for active queue management offload, comprising:
a memory configured to store instructions and queue data; and
a traffic offload processor coupled to the memory, and configured to:
collect hardware resource usage data of the network device periodically;
determine a congestion alarm threshold based on the collected hardware resource usage data;
classify a plurality of incoming packets into a first queue as first packets or into a second queue as second packets based on an explicit congestion notification (ECN) field in a header of each incoming packet;
mark the ECN field in the header of each of the plurality of incoming packets when a current hardware resource usage statistic meets the congestion alarm threshold; and
schedule transmission of the first packets from the first queue and the second packets from the second queue using an aging monitor, wherein the first packets from the first queue are transmitted prior to the second packets from the second queue when a non-served time of the first queue exceeds a predetermined aging interval threshold.

11. The network device of claim 10, wherein the hardware resource usage data comprises at least one of a buffer used rate, a buffer occupied period, a used packet ring size, a used computing rate, used power, or used DMA buffers.

12. The network device of claim 10, wherein the traffic offload processor is further configured to determine, by a relearning timer, an interval for cleaning historical statistic data to adaptively adjust the congestion alarm threshold.

13. The network device of claim 12, wherein the traffic offload processor is configured to clean the history statistic data partially or fully upon a timeout event of the relearning timer.

14. The network device of claim 13, wherein the traffic offload processor is further configured to continue marking the ECN field until the congestion alarm threshold is cleared by the hardware resource usage statistic or a timeout of the relearning timer occurs.

15. The network device of claim 10, wherein the traffic offload processor is further configured to determine a weighted moving average (WMA) of the hardware resource usage data.

16. The network device of claim 15, wherein the weighted moving average is determined using a current use rate of a queue and a weight of a current use rate.

17. The network device of claim 10, wherein the traffic offload processor further is configured to transmit the first packets from the first queue prior to the second packets from the second queue when the number of first packets in the first queue is higher than the number of second packets in the second queue.

18. The network device of claim 10, wherein the memory is further configured to store the plurality of incoming packets, and the traffic offload processor is further configured to generate packet metadata corresponding to each of the plurality of incoming packets and update the packet metadata to mark the ECN field.
